(19) United States
(12) Patent Application Publication
(10) Pub. No.: US 2026/0300005 A1
(43) Pub. Date: Oct. 1, 2026

(54) METHOD FOR TASK PROCESSING, ELECTRONIC DEVICE, AND STORAGE MEDIUM

(71) Applicant: Lenovo (Beijing) Limited, Beijing (CN)

(72) Inventor: Dong CHEN, Beijing (CN)

(21) Appl. No.: 19/633,489

(22) Filed: Mar. 30, 2026

(30) Foreign Application Priority Data
Mar. 31, 2025 (CN) 202510398601.0

(51) Int. Cl. G06F 9/48

(52) U.S. Cl. CPC G06F 9/4881

(57) ABSTRACT

The present disclosure discloses a method for task processing. The method includes: in response to a target task being triggered, determining a target length corresponding to the target task; based on the target length, determining a first target model matching the target length from a plurality of first models, where each of the plurality of first models includes a model library file and a configuration file, the configuration file being configured to define a supported task length of a respective first model, such that the plurality of first models support different task lengths; and, executing the target task using the first target model.

### CROSS-REFERENCE S TO RELATED APPLICATIONS

The present disclosure claims priority to Chinese Patent Application No. 202510398601.0, filed on Mar. 31, 2025, the content of which is incorporated herein by reference in its entirety.

### TECHNICAL FIELD

The present disclosure relates to, but is not limited to, the field of artificial intelligence, and more particularly, to a method and a device for task processing.

### BACKGROUND

When performing inference using a model, a system is required to first pad or truncate task information input by a user such that the padded or truncated task information matches a length supported by the model, so that the task may be executed using the model. However, in most cases, a text length of the user input is less than the length supported by the model, resulting in that actual input to the model includes a relatively large amount of invalid data. This not only reduces computational efficiency of the model, but also adversely affects computing capability and bandwidth of a processor.

### SUMMARY

One aspect of the present disclosure provides a method for task processing. The method includes: in response to a target task being triggered, determining a target length corresponding to the target task; based on the target length, determining a first target model matching the target length from a plurality of first models, where each of the plurality of first models includes a model library file and a configuration file, the configuration file being configured to define a supported task length of a respective first model, such that the plurality of first models support different task lengths; and, executing the target task using the first target model.

Another aspect of the present disclosure provides an electronic device. The electronic device includes: a memory and one or more processors. The memory is configured to store a target application, where the target application is configured to receive user input triggering a target task. The one or more processors are configured to: in response to the target task being triggered, determine a target length corresponding to the target task; based on the target length, determine a first target model matching the target length from a plurality of first models, where each of the plurality of first models includes a model library file and a configuration file, the configuration file being configured to define a supported task length of a respective first model, such that the plurality of first models support different task lengths; and, execute the target task using the first target model.

Yet another aspect of the present disclosure provides a non-transitory computer-readable storage medium storing a computer program that, when executed by at least one processor, causes the at least one processor to perform operations. The operations include: in response to a target task being triggered, determining a target length corresponding to the target task; based on the target length, determining a first target model matching the target length from a plurality of first models, where each of the plurality of first models includes a model library file and a configuration file, the configuration file being configured to define a supported task length of a respective first model, such that the plurality of first models support different task lengths; and, executing the target task using the first target model.

### BRIEF DESCRIPTION OF THE DRAWINGS

The accompanying drawings are incorporated into and form a part of the specification. The drawings illustrate embodiments consistent with the present disclosure and, together with the specification, serve to explain the technical solutions of the present disclosure.

FIG. 1 illustrates a schematic flowchart of an implementation of a method for task processing in accordance with some embodiments of the present disclosure.

FIG. 2 illustrates a schematic flowchart of an implementation of another method for task processing in accordance with some embodiments of the present disclosure.

FIG. 3 illustrates a schematic flowchart of an implementation of yet another method for task processing in accordance with some embodiments of the present disclosure.

FIG. 4 illustrates a schematic structural diagram of a task processing apparatus in accordance with some embodiments of the present disclosure.

FIG. 5 illustrates a schematic hardware entity diagram of an electronic device in accordance with some embodiments of the present disclosure.

### DETAILED DESCRIPTION

To make the objectives, technical solutions, and advantages of the present disclosure clearer, the technical solutions of the present disclosure are further described in detail below with reference to the accompanying drawings and embodiments. The embodiments described herein should not be construed as limiting the present disclosure. All other embodiments obtained by those of ordinary skill in the art without creative work fall within the scope of protection of the present disclosure.

In the following description, “some embodiments” describe a subset of all possible embodiments. However, it should be understood that “some embodiments” may be the same subset or different subsets of all possible embodiments and may be combined with each other without conflict.

It should be noted that the terms “first/second/third” involved in some embodiments of the present disclosure are merely used to distinguish similar objects and do not represent a specific ordering of the objects. It should be understood that “first/second/third” may be interchangeable in a specific order or sequence when permitted, such that some embodiments of the present disclosure described herein may be implemented in an order other than the order illustrated or described herein.

Those skilled in the art should understand that, unless otherwise defined, all terms (including technical terms and scientific terms) used herein have meanings consistent with the general understanding of those of ordinary skill in the art in the field of some embodiments of the present disclosure. It should also be understood that terms defined in general dictionaries should be interpreted as having meanings consistent with their meanings in the context of the existing technology, and, unless specifically defined herein, should not be interpreted in an idealized or overly formal sense.

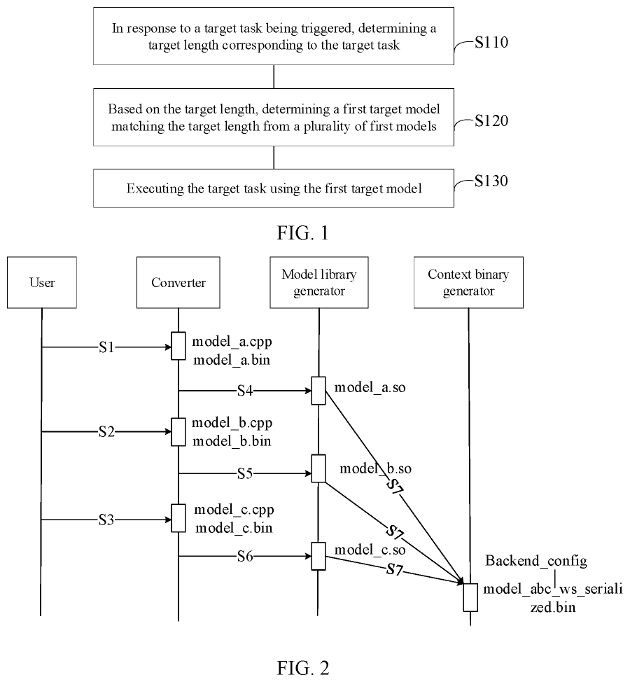

Some embodiments of the present disclosure provide a method for task processing. As shown in FIG. 1, the method includes steps S110 to S130.
Step S110: in response to a target task being triggered, determining a target length corresponding to the target task.

In some embodiments of the present disclosure, the target task may be triggered via a target application.

For example, a user performs user input via a display interface of the target application, and the target application triggers the target task after receiving task input information of the user input.

For example, when a user executes a first application, the first application, during running, triggers startup of the target application and sends task input information to the target application, such that the target application triggers the target task after receiving the task input information.

In some embodiments of the present disclosure, task input information corresponding to the target task is obtained, and the target length is determined based on the task input information.
Step S120: based on the target length, determining a first target model matching the target length from a plurality of first models.

In some embodiments, each of the plurality of first models includes a model library file and a configuration file. Specifically, the model library file includes a weight file of a model, and the configuration file includes a Key-Value (KV) cache precomputed for an input sequence.

In some implementations, the plurality of first models may share a common model library file or share a set of base weight data. Each of the plurality of first models is associated with a respective configuration file corresponding to a supported task length.

For example, when a target length of an input token sequence is determined to be 4, a configuration file including a KV cache corresponding to 4 tokens is loaded and used; and, when a target length of an input token sequence is determined to be 5, a configuration file including a KV cache corresponding to 5 tokens is loaded and used.

In this manner, by loading a configuration file corresponding to the target length, a precomputed KV cache may be reused, thereby reducing computational overhead and improving inference efficiency.

Accordingly, different first models correspond to different supported task lengths. A target task may be executed using a first model corresponding to the target length.

Specifically, a first model refers to a conceptual model that utilizes a computer's capability of processing information in large quantities and at high speed to define certain laws or rules of an objective system through programming and to operate based on data, so as to observe and predict a state of the objective system. The first model may be a neural network model, an artificial intelligence model, or a machine learning model.

It should be understood that the plurality of first models may execute the same task. When task input information corresponding to the plurality of first models is the same, outputs of the plurality of first models after executing the task are the same.

In some embodiments of the present disclosure, lengths of tasks respectively supported by the plurality of first models are obtained, and a first target model matching the target length is determined from the lengths of tasks respectively supported by the plurality of first models.

For example, a fourth length equal to the target length is determined from the lengths of tasks respectively supported by the plurality of first models, and a first model corresponding to the fourth length is determined as the first target model.

For example, a fourth length that is greater than the target length and has a minimum difference from the target length is determined from the lengths of tasks respectively supported by the plurality of first models, and a first model corresponding to the fourth length is determined as the first target model.

It should be understood that, if the fourth length is less than the target length, the task input information is required to be truncated before the first target model executes the target task, such that a first processing length corresponding to the truncated task input information equals the fourth length, thereby enabling the first target model to execute the target task. However, such truncation may adversely affect output accuracy of the target task. Therefore, the fourth length should be greater than or equal to the target length. In other words, the fourth length supported by the first target model may be equal to the target length or greater than the target length.

Further, when the fourth length is greater than the target length, before the first target model executes the target task, the task input information is required to be padded such that a second processing length corresponding to the padded task input information is equal to the fourth length, thereby enabling the first target model to execute the target task. However, excessive padding may occur under such circumstances. If the task input information is padded excessively, execution efficiency of the first target model may be adversely affected. Therefore, a difference between the fourth length and the target length is preferably minimized.
Step S130: executing the target task using the first target model.

Where the plurality of first models support different task lengths.

In some embodiments of the present disclosure, when the target task is executed using the first target model, a loading state of the first target model is a loaded state. Therefore, prior to executing the target task using the first target model, the loading state of the first target model is required to be obtained.

In some embodiments of the present disclosure, when the loading state of the first target model is an unloaded state, the first target model is loaded into the target space based on the loading mode of the model.

For example, when the loading mode is a first mode and a model exists in the target space, the model in the target space is unloaded, and the first target model is loaded into the target space.

For example, when the loading mode is the first mode and no model exists in the target space, the first target model is loaded into the target space.

For example, when the loading mode is a second mode, the plurality of first models are loaded into the target space, where the plurality of first models include the first target model.

In some embodiments of the present disclosure, when the loading state of the first target model is a loaded state, the target task is executed using the first target model.

For example, when a length supported by the first target model is equal to the target length, the task input information is input into the first target model to run the first target model; after the first target model finishes running, a model output of the first target model is obtained; and the model output is determined as an output of the target task.

For example, when a length supported by the first target model is greater than the target length, the task input information is padded such that a length of the padded task input information is equal to the length supported by the first target model; the padded task input information is input into the first target model to run the first target model; after the first target model finishes running, a model output of the first target model is obtained; and the model output is determined as an output of the target task.

It should be understood that the plurality of first models support different task lengths. Accordingly, a length matching the target length may be determined from the plurality of first models based on the target length, thereby obtaining the first target model.

In some embodiments of the present disclosure, a target length corresponding to a target task is first determined. Then a first target model matching the target length is determined from a plurality of first models. When inference is performed using the first target model, because a length supported by the first target model is closest to the target length, padding applied to task input information corresponding to the target task is minimized. Using this approach, on one hand, execution efficiency of the first target model is improved, and waste of processor computing capability and bandwidth resources is reduced. On the other hand, model development workload is effectively reduced, and a model development cycle is shortened.

In some embodiments, before step S110, the method for task processing further includes step S210 and step S220.
Step S210: obtaining a loading mode of a model, where the loading mode is determined based on resource information of a target space and information of the model, or is a selection of the loading mode received from a user.

Specifically, the loading mode refers to a manner or method of loading a pre-trained model into an application or an inference environment.

In some embodiments of the present disclosure, the loading mode of the model may be automatically determined by a target application or may be manually determined by the user.

For example, the target application determines the loading mode of the model based on the resource information of the target space and the information of the model.

For example, the user selects the loading mode of the model using the target application.

In some embodiments of the present disclosure, the resource information of the target space may include first memory information of the target space, and the information of the model includes second memory information. In this way, the loading mode of the model is determined based on the first memory information and the second memory information.

For example, when the model represents a single first model, and the second memory information is less than or equal to the first memory information and the first memory information is less than a plurality of second memory information, the loading mode is determined as the first mode.

For example, when the model represents the plurality of first models, the first memory information may be greater than or equal to the second memory information, and the loading mode is determined as the second mode.
Step S220: loading at least one model of the plurality of first models based on the loading mode of the model.

Specially, the loading mode of the model includes the first mode and the second mode. The first mode refers to loading a single first model into the target space, and the second mode refers to loading at least two first models of the plurality of first models into the target space.

In some embodiments of the present disclosure, in the second mode, a quantity of the plurality of first models to be loaded into the target space and corresponding first models are determined based on the first memory information and the second memory information.

In some embodiments of the present disclosure, after the loading mode of the model is obtained, at least one model of the plurality of first models is loaded according to the loading mode of the model. In this way, model loading may be performed in advance when the target application starts. Therefore, if a preloaded model is the first target model, waiting time for the output of the target task may be reduced.

In some embodiments, step S220, loading at least one model of the plurality of first models based on the loading mode of the model, includes steps S221 to S223.
Step S221: when the loading mode of the model is the first mode, obtaining a historical target length of a historical target task.

In some embodiments of the present disclosure, when the target application starts, a historical task information list of the target application is obtained, and the historical target length corresponding to the historical target task is determined from the historical task information list.

For example, a most recent historical task in the historical task information list may be determined as the historical target task, and a length corresponding to the historical target task is determined as the historical target length.

For example, each historical task in the historical task information list is determined as a historical target task; a length corresponding to each historical target task is obtained; a quantity of each length is counted; and a length having the greatest quantity is determined as the historical target length.

For example, a preset number of historical tasks are obtained from the historical task information list and determined as historical target tasks; lengths respectively corresponding to the preset number of historical target tasks are obtained; and a value obtained by averaging all of the lengths is determined as the historical target length.
Step S222: based on the historical target length, determining a second target model from the plurality of first models.

In some embodiments of the present disclosure, based on the historical target length, a second target model matching the historical target length is determined from the plurality of first models.

That is, a fifth length corresponding to the second target model is equal to the historical target length, or the fifth length is greater than the historical target length and has a minimum difference from the historical target length.
Step S223: loading the second target model into the target space.

In some embodiments of the present disclosure, the second target model may be stored in a local file system. Accordingly, when the second target model is loaded into the target space, the second target model may be read from the local file system and loaded into the target space.

In some embodiments of the present disclosure, the second target model may be obtained via a specified URL. Accordingly, when the second target model is loaded into the target space, a model file is downloaded from a remote server via the specified URL and loaded into the target space.

In some embodiments of the present disclosure, after the loading mode of the model is determined to be the first mode, on one hand, the model is loaded according to the first mode, such that model preloading is implemented when the target application starts. On the other hand, because the second target model is determined based on the historical target task, the preloaded model is better adapted to a user's usage habit, such that when the user triggers the target task again, the target length corresponding to the target task is more easily adapted to the second target model.

In some embodiments, step S220, loading at least one model of the plurality of first models based on the loading mode of the model, includes step S224.
Step S224: when the loading mode of the model is the second mode, loading the plurality of first models into the target space, such that the first target model is determined from the plurality of first models loaded into the target space.

In some embodiments of the present disclosure, when the loading mode is the second mode, the plurality of first models may be loaded into the target space such that loading states of the plurality of first models are all in a loaded state. Accordingly, after the first target model is determined, the target task may be executed using the first target model.

In some embodiments of the present disclosure, after the loading mode of the model is obtained as the second mode, on one hand, the plurality of first models are loaded according to the second mode, such that model preloading is implemented when the target application starts. On the other hand, when the first target model is determined, the first target model may directly execute the target task without requiring an additional loading operation. Accordingly, a waiting time for output of the target task may be reduced.

In some embodiments, before step S220, the method further includes step S225.
Step S225: when the loading mode of the model is the second mode, determining a quantity of the plurality of first models and corresponding first models based on the resource information of the target space and a user's model usage behavior.

In some embodiments of the present disclosure, based on the user's model usage behavior, a plurality of fourth models matching the usage behavior are obtained from a plurality of third models. When the resource information of the target space satisfies simultaneous loading of the plurality of fourth models, the plurality of fourth models are determined as the plurality of first models.

In some embodiments of the present disclosure, based on the user's model usage behavior, the plurality of fourth models matching the usage behavior are obtained from the plurality of third models. When the resource information of the target space does not satisfy a condition for simultaneous loading the plurality of fourth models, a plurality of first models satisfying the resource information of the target space are determined from the plurality of fourth models.

In some embodiments of the present disclosure, the plurality of fourth models may be obtained based on the user's model usage behavior recorded on the target application.

For example, the target application may obtain a most recent usage time of each model from historical usage records of the models, and a plurality of fourth models satisfying a preset time are selected from the plurality of third models.

For example, the target application may obtain historical usage records of the models, obtain a usage count of each model from the historical usage records, and select a plurality of fourth models satisfying a preset count condition from the plurality of third models.

In some embodiments of the present disclosure, based on the resource information of the target space and the user's model usage behavior, the quantity of the plurality of first models to be loaded and corresponding first models under the second mode are determined. By this approach, on one hand, resources of the target space may be utilized in a reasonable manner; on the other hand, the plurality of first models that are loaded may be better adapted to the user behavior.

In some embodiments, step S120, based on the target length, determining the first target model corresponding to the target length from the plurality of first models, includes step S121 and step S122.
Step S121: when the loading mode of the model is the first mode, if a second target model loaded into the target space matches the target length, using the second target model as the first target model to process the target task.

In some embodiments of the present disclosure, a fifth length of the second target model is obtained. When the fifth length is equal to the target length, the second target model is used as the first target model.

In some embodiments of the present disclosure, the fifth length of the second target model is obtained. When the fifth length is greater than the target length and has a minimum difference from the target length, the second target model is used as the first target model.
Step S122: if the second target model loaded into the target space does not match the target length, determining the first target model corresponding to the target length from the plurality of first models, loading the first target model into the target space, and removing the second target model.

In some embodiments of the present disclosure, when the second target model loaded into the target space does not match the target length, the first target model is determined from unloaded first models of the plurality of first models, and after removing the second target model from the target space, the first target model is loaded into the target space.

In some embodiments, the above step S110, determining the first target model corresponding to the target length from the plurality of first models based on the target length, includes steps S111 to S113.
Step S111: obtaining task input information corresponding to the target task.

In some embodiments of the present disclosure, the task input information may include user input. The user input includes, but is not limited to, at least one of text input, audio input, image input, or video input.
Step S112: when the task input information does not indicate an expected output length of the target task, determining the target length based on a first length.

In some embodiments of the present disclosure, a second length represented by the task input information is obtained, and the second length is determined as the first length.

For example, when the task input information is text input, a character length corresponding to the text input is determined as the first length.

For example, when the task input information is audio input, an audio length corresponding to the audio input is obtained and determined as the first length. The audio length may be determined by an audio processing library, or the audio length may be determined by calculating a total sample count and a sampling rate.

For example, when the task input information is video input, a video length corresponding to the video input is obtained and determined as the first length. The video length may be determined by video processing software, the video length may be determined by a command-line tool, or the video length may be determined by programming.

For example, when the task input information is image input, an image length corresponding to the image input is obtained and determined as the first length. The image length may be determined by image viewing software, the image length may be determined by a command-line tool, or the image length may be determined by programming.

In some embodiments of the present disclosure, target information associated with the task input information is determined; a sixth length corresponding to the target information is obtained; and the first length is determined based on the sixth length and the second length.

In some embodiments of the present disclosure, the first length is determined as the target length.
Step S113: when the task input information indicates the expected output length, determining the target length based on the first length and the expected output length.

The first length includes the second length represented by the task input information, or includes the second length and a third length represented by the target information; and the target information is associated with the task input information.

In some embodiments of the present disclosure, a sum of the first length and the expected output length is determined as the target length.

In some embodiments of the present disclosure, a value obtained by multiplying a larger value of the first length and the expected output length by 2 is determined as the target length.

In some embodiments of the present disclosure, a value obtained by a smaller value of the first length and the expected output length by 2 is determined as the target length.

In some embodiments of the present disclosure, a method for determining the target length is provided, such that when the target task is triggered, the target length corresponding to the target task is obtained based on the target-length determination method described above.

In some embodiments, after step S130, the method for task processing further includes step S140.
Step S140: when no new instruction is received within a time period after completion of the target task, removing the first target model or the plurality of first models from the target space.

In some embodiments of the present disclosure, when the loading mode is the first mode, the first target model is removed from the target space.

In some embodiments of the present disclosure, when the loading mode is the second mode, the plurality of first models are removed from the target space.

In some embodiments of the present disclosure, when no new instruction is received within a preset duration after completion of the target task, the first target model or the plurality of first models are removed from the target space.

In some embodiments of the present disclosure, when a model release instruction is received, the first target model or the plurality of first models are removed from the target space.

In some embodiments of the present disclosure, a model removal method for the target space is provided. In this way, when the target task is not triggered, models in the target space are removed, and the target space is used in other scenarios, thereby achieving reasonable utilization of the target space.

In some embodiments, after step S110, the method for task processing further includes step S310.
Step S310: merging the plurality of first models to determine a fifth model, where the fifth model includes the first target model.

Correspondingly, step S120 may be: based on the target length, determining the first target model matching the target length from the fifth model.

In some embodiments of the present disclosure, by merging the plurality of first models into a unified fifth model, the system is not required to manage the plurality of first models separately. Unified management of the plurality of first models is implemented using the fifth model, thereby simplifying a management procedure for the plurality of first models.

In some embodiments, step S310, merging the plurality of first models to determine the fifth model, includes steps S311 to S314.
Step S311: obtaining model files respectively corresponding to the plurality of first models.

In some embodiments of the present disclosure, a model file includes at least executable code of a first model and configuration information of the first model.
Step S312: splitting model files corresponding to the plurality of first models to obtain a first file and a second file, where the first file includes at least executable code in the model file, the second file includes at least configuration information in the model file, and the configuration information includes at least a length supported by the first model.
Step S313: storing the first files respectively corresponding to the plurality of first models in a preset order to obtain a third file, and storing the second files respectively corresponding to the plurality of first models in a preset order to obtain a fourth file.
Step S314: determining the fifth model based on the fourth file and the third file.

In some embodiments, before step S110, the method for task processing further includes steps S320 and step S330.
Step S320: obtaining a loading mode of the fifth model, where the loading mode is determined based on the resource information of the target space and resource information of the fifth model.
Step S330: loading the fifth model based on the loading mode.

In some embodiments, step S330, loading the fifth model based on the loading mode, includes steps S331 to S333.
Step S331: when the loading mode is the first mode, obtaining the historical target length of the historical target task.
Step S332: based on the historical target length, determining the second target model from the fifth model.
Step S333: loading the second target model into the target space.

In some embodiments, step S330, loading the fifth model based on the loading mode, includes step S334.
Step S334: when the loading mode is the second mode, loading the fifth model into the target space.

An application of some embodiments of the present disclosure in a practical scenario is described below.

In usage scenario of an artificial intelligence computer (AI Computer, AIPC), power consumption requirements are relatively strict. Particularly, when the AIPC is applied to perform inference for a large language model, a neural processing unit (Neural Processing Unit, NPU) exhibits significant advantages, where its power consumption is about ⅓ of an integrated graphics processing unit (iGPU, Integrated Graphics Processing Unit).

However, a large language model inference software stack on the NPU supports only a static input text length. This length is set to a maximum static input text length that the model is capable of processing, namely max_input_token_len. If an input text length of input text entered by a user is less than the maximum static input text length, the input text is padded such that the input text length is equal to the maximum static input text length. If the input text length is greater than the maximum static input text length, the input text is truncated such that the input text length is equal to the maximum static input text length.

When inference is performed using the large language model, the system first inputs the padded or truncated input text into the large language model. After receiving the input text, the large language model processes the input text and outputs a first token after completion of processing. A time for outputting the token is referred to as first-token latency.

In most cases, the input text length is less than the maximum static input text length, resulting in that actual text input finally input into the large language model includes a large amount of invalid padded data. Such padded data not only wastes NPU computing capability and bandwidth resources, but also ultimately results in relatively long first-token latency.

In the existing technology, a software stack supporting dynamic input lengths is developed. However, this approach requires a wide range of upgrades to the NPU inference software stack, leading to huge development workload and a relatively long cycle.

Based on this, some embodiments of the present disclosure provide a method for compressing first-token latency on an AIPC NPU. The method first merges a plurality of first computation graphs supporting different lengths to obtain a merged second computation graph (namely the fifth model described above). Then, according to an input text length corresponding to user input, a first computation graph closest to the input text length is selected from the second computation graph to perform inference computation. In this way, because the input text length (namely the target length described above) is closest to a length supported by the finally selected first computation graph (namely the first target model described above), padding data for the input text is reduced, thereby reducing computing power and bandwidth waste. In addition, because each first computation graph may be applied in the same scenario, a plurality of model parameters included in each first computation graph have the same parameter types and the same parameter values, and model weights of each first computation graph may be shared. Therefore, for each additional computation graph, increased memory usage is within 10 M, which is substantially negligible compared with NPU memory capacity of 8 G/16 G.

Further, there are two computation graph loading modes when performing inference: a selection mode (namely the second model described above) and a switching mode (namely the first mode described above).

Selection mode: loading all computation graphs into memory, and then performing inference using a corresponding computation graph as required.

Switching mode: keeping only one computation graph in memory. If a text range of input data changes, a new computation graph is loaded and an unused computation graph is destroyed.

It should be noted that the computation graph loading mode is related to memory resources of the system. For example, when memory resources are sufficient, the selection mode may be adopted; when memory resources are limited, the switching mode may be adopted.

The embodiments below describe merging computation graphs and using computation graphs, respectively, as examples.
Embodiment 1: merging computation graphs.

When merging computation graphs, first, a plurality of first computation graphs are respectively generated, by a converter and a model library generator, into different model files supporting different lengths, where each model file corresponds to one computation graph. Then, a context binary generator is used to merge model files corresponding to all first computation graphs into a final unified binary file and a configuration file.

As shown in FIG. 2, merging computation graphs includes the following steps.
Step S1: a user inputs a first computation graph A.

Specifically, after receiving the first computation graph A, the converter converts the first computation graph A into an intermediate format file required for running the model on the NPU. As shown, the converter converts the computation graph A into a model_a.cpp file (namely the first file described above) and a model_a.bin file (namely the second file described above).
Step S2: the user inputs a first computation graph B.

Specifically, after receiving the first computation graph B, the converter converts the first computation graph B into an intermediate format file required for running the model on the NPU. As shown, the converter converts the computation graph B into a model_b.cpp file and a model_b.bin file.
Step S3: the user inputs a first computation graph C.

Specifically, after receiving the first computation graph C, the converter converts the first computation graph C into an intermediate format file required for running the model on the NPU. As shown, the converter converts the computation graph C into a model_c.cpp file and a model_c.bin file.
Step S4: the converter sends the model_a.cpp file and the model_a.bin file to the model library generator.

Specifically, the model library generator is configured to convert received cpp files and bin files into a shared library file capable of running on the NPU. For the model_a.cpp file and the model_a.bin file, the model library generator converts the two files into a model_a.so file.
Step S5: the converter sends the model_b.cpp file and the model_b.bin file to the model library generator.

Specifically, for the model_b.cpp file and the model_b.bin file, the model library generator converts the two files into a model_b.so file.
Step S6: the converter sends the model_c.cpp file and the model_c.bin file to the model library generator.

Specifically, for the model_c.cpp file and the model_c.bin file, the model library generator converts the two files into a model_c.so file.
Step S7: the model library generator sends the shared library files to the context binary generator.

Specifically, after receiving the shared library files, the context binary generator reads the received shared library files and merges them to generate a final unified binary file (for example, a model_abc_ws_serialized.bin file, namely the third file described above) and a configuration file (for example, a backend_config file, namely the fourth file described above). The shared library files include the model_a.so file, the model_b.so file, and the model_c.so file.

It should be noted that lengths respectively supported by the first computation graph A, the first computation graph B, and the first computation graph C are stored in the configuration file.
Embodiment 2: applying computation graphs.

After completion of computation graph merging, a computation graph is first loaded into memory according to a loading mode of the computation graph. If a selection mode is adopted, a second computation graph is loaded; if a switching mode is adopted, any one of the first computation graphs is loaded. During inference, if a length of input text does not match a computation graph currently loaded in memory, then under the selection mode, switching to a corresponding computation graph for execution may be performed directly. Under the switching mode, a currently loaded first computation graph is unloaded, and a target computation graph adapted to the input text length (i.e., the first target model) is loaded. Further, after completion of inference, under the selection mode, the second computation graph is unloaded; and under the switching mode, the currently loaded first computation graph is unloaded.

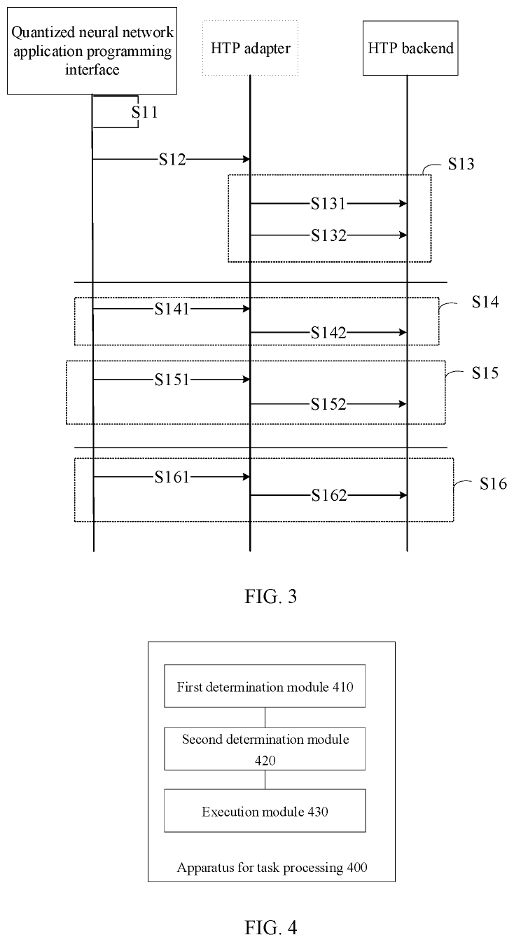

As shown in FIG. 3, applying computation graphs includes the following steps.
Step S11: initializing a quantized neural network application programming interface (QNN API) to load a runtime environment for computation graphs.

Specifically, the initialization process includes reading the backend_config file and the model_abc_ws_serialized.bin file of the second computation graph, and setting runtime parameters required for running the second computation graph based on the two read files. The runtime parameters may include: a type of the loaded second computation graph, a first computation graph corresponding to the second computation graph, an address and a path of a binary file corresponding to the second computation graph, model parameters corresponding to the second computation graph, and the like. After initialization is completed, a structure of the second computation graph is generated. The structure stores parameters required for running the second computation graph.
Step S12: the QNN API sends parameters required for running the computation graph to an HTP adapter.

Specifically, after receiving the parameters required for running the computation graph, the HTP adapter forwards the parameters required for running the computation graph to an HTP backend. In implementation, the parameters required for running the computation graph may be sent via Qnncontext_createFronmBinary( . . . , cfgs, . . . ).
Step S13: the HTP backend performs mode loading based on the received parameters required for running the computation graph.

Specifically, the HTP backend first obtains a loading mode of the second computation graph and loads the computation graph according to the loading mode of the second computation graph.

In implementation, step S131: when the loading mode is determined as the selection mode, the second computation graph is loaded; and, step S132: when the loading mode is determined as the switching mode, the first computation graph A is loaded.

It should be noted that the HTP backend may also be used to execute a computation graph, and how to obtain the loading mode of the computation graph is determined based on content in the configuration file.
Step S14: executing the first computation graph A.

Specifically, the selection mode is used as an example. In this mode, the first computation graph A has been loaded into memory. Therefore, after receiving a task instruction, the HTP backend executes a computation task of the first computation graph A.

In implementation, step S141: the QNN API sends a first execution instruction of the first computation graph A (namely QnnGraph_execute(graph_a)) to the HTP adapter; and, step S142: after receiving the first execution instruction of the first computation graph A, the HTP adapter parses the instruction, encapsulates the instruction into a second execution instruction of the first computation graph A recognizable by the HTP backend (namely execute graph_a), and sends the second execution instruction to the HTP backend. After receiving the second execution instruction of the first computation graph A, the HTP backend executes the computation task of the first computation graph A.
Step S15: executing the first computation graph B.

Specifically, the switching mode is used as an example. In this mode, the first computation graph B is not loaded into memory. Therefore, after receiving the task instruction, the HTP backend loads the first computation graph B into memory and executes a computation task of the first computation graph B.

In implementation, step S151: the QNN API sends a first execution instruction of the first computation graph B (namely QnnGraph_execute(graph_b)) to the HTP adapter; and, step S152: after receiving the first execution instruction of the first computation graph B, the HTP adapter parses the instruction, encapsulates the instruction into a second execution instruction of the first computation graph B recognizable by the HTP backend (namely execute graph_b), and sends the second execution instruction to the HTP backend. After receiving the second execution instruction of the first computation graph B, the HTP backend unloads the currently loaded first computation graph A from memory, loads the first computation graph B, and, after loading is completed, executes the computation task of the first computation graph B.

It should be noted that steps S11 to S13 are an initialization process. Through this process, the HTP backend obtains the second computation graph. Steps S14 and S15 represent the usage of the second computation graph.
Step S16: de-initialization.

Specifically, step S161: the QNN API sends a first release instruction of the computation graph (namely QnnContext_free()) to the HTP adapter; and, step S162: after receiving the first release instruction of the computation graph, the HTP adapter parses the instruction, encapsulates the instruction into a second release instruction of the computation graph recognizable by the HTP backend, and sends the second release instruction to the HTP backend. After receiving the second release instruction of the computation graph, the HTP backend performs a release task of the computation graph.

In implementation, the HTP backend first obtains the loading mode of the computation graph. When the loading mode is the selection mode, the second computation graph in memory is unloaded. When the loading mode is the switching mode, the first computation graph in memory is unloaded.

Based on the foregoing embodiments, some embodiments of the present disclosure provide an apparatus for task processing. The apparatus includes units included therein and modules included in the units. The apparatus may be implemented by a processor in an electronic device. Alternatively, the apparatus may be implemented by specific logic circuits. During implementation, the processor may be a central processing unit (Central Processing Unit, CPU), a microprocessor unit (Microprocessor Unit, MPU), a digital signal processor (Digital Signal Processor, DSP), a field programmable gate array (Field Programmable Gate Array, FPGA), or the like.

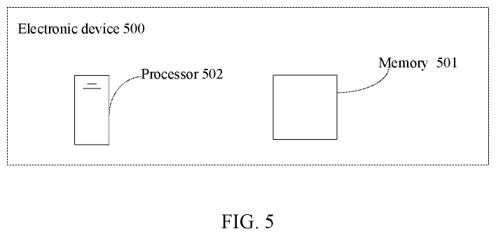

FIG. 4 illustrates a schematic structural diagram of an apparatus for task processing according to some embodiments of the present disclosure. As shown in FIG. 4, the apparatus for task processing 400 includes:
a first determination module 410 configured to, in response to a target task being triggered, determine a target length corresponding to the target task;
a second determination module 420 configured to, based on the target length, determine a first target model matching the target length from a plurality of first models; and
an execution module 430 configured to execute the target task using the first target model.

Where, the plurality of first models support different task lengths.

In some embodiments, the apparatus further includes:
an obtaining module configured to obtain a loading mode of a model, where the loading mode is determined based on resource information of a target space and information of the model, or is a selection of the loading mode received from a user; and
a loading module configured to load at least one model of the plurality of first models based on the loading mode of the model.

In some embodiments, the loading module includes:
a first obtaining unit configured to, when the loading mode of the model is a first mode, obtain a historical target length of a historical target task;
a first determination unit configured to, based on the historical target length, determine a second target model from the plurality of first models; and
a first loading unit configured to load the second target model into the target space.

In some embodiments, the loading module includes:
a second loading unit configured to, when the loading mode of the model is a second mode, load the plurality of first models into the target space, such that the first target model is determined from the plurality of first models loaded into the target space.

In some embodiments, the loading module further includes:
a second determination unit configured to, when the loading mode of the model is the second mode, determine a quantity of the plurality of first models and corresponding first models based on resource information of the target space and a user's model usage behavior.

In some embodiments, the second determination module includes:
a processing unit configured to, when the loading mode of the model is the first mode, if a second target model loaded into the target space matches the target length, use the second target model as the first target model to process the target task; and
a third determination unit configured to, if the second target model loaded into the target space does not match the target length, determine the first target model corresponding to the target length from the plurality of first models, load the first target model into the target space, and remove the second target model.

In some embodiments, the first determination module includes:
a second obtaining unit configured to obtain task input information corresponding to the target task;
a fourth determination unit configured to, when the task input information does not indicate an expected output length of the target task, determine the target length based on a first length; and
a fifth determination unit configured to, when the task input information indicates the expected output length, determine the target length based on the first length and the expected output length.

Where, the first length includes a second length represented by the task input information, or includes the second length and a third length represented by target information, and the target information is associated with the task input information.

In some embodiments, the apparatus further includes:
a removal module configured to, when no new instruction is received within a time period after completion of the target task, remove the first target model or the plurality of first models from the target space.

The foregoing description of the apparatus embodiments is similar to the foregoing description of the method embodiments and has similar beneficial effects as the method embodiments. In some embodiments, the functions of the apparatus provided in some embodiments of the present disclosure or the modules included therein may be used to perform the methods described in the foregoing method embodiments. For technical details not disclosed in the apparatus embodiments of the present disclosure, reference may be made to the description of the method embodiments of the present disclosure.

It should be noted that, in some embodiments of the present disclosure, if the foregoing data processing method is implemented in the form of software functional modules and sold or used as an independent product, the method may also be stored in a computer-readable storage medium. Based on such understanding, the technical solutions of some embodiments of the present disclosure, or a part contributing to related technologies, may be embodied in the form of a software product. The software product is stored in a storage medium and includes instructions that, when executed, cause an electronic device (which may be a personal computer, a server, a network device, or the like) to perform all or some steps of the methods of some embodiments of the present disclosure. The storage medium includes, for example, a USB flash drive, a mobile hard disk, a read-only memory (Read Only Memory, ROM), a magnetic disk, an optical disk, or various media capable of storing program code. Accordingly, some embodiments of the present disclosure are not limited to any particular hardware, software, or firmware, or any combination of hardware, software, and firmware.

Some embodiments of the present disclosure provide an electronic device including a processor and a memory. FIG. 5 illustrates a schematic structural diagram of an electronic device according to some embodiments of the present disclosure. As shown in FIG. 5, the electronic device 500 includes:
a memory 501 configured to store a target application, where the target application is configured to receive user input that triggers a target task; and
a processor 502 configured to, in response to the target task being triggered, determine a target length corresponding to the target task; based on the target length, determine a first target model matching the target length from a plurality of first models; and, execute the target task using the first target model, where the plurality of first models support different task lengths.

In some embodiments, the device further includes:
a memory, including a target space, configured to load the first target model, so as to execute the target task using the first target model.

Some embodiments of the present disclosure provide a computer-readable storage medium storing a computer program. When executed by a processor, the computer program implements some or all steps of the foregoing method. The computer-readable storage medium may be transient or non-transient.

Some embodiments of the present disclosure provide a computer program including computer-readable code. When the computer-readable code runs in an electronic device, the processor in the electronic device executes steps for implementing some or all steps of the foregoing method.

Some embodiments of the present disclosure provide a computer program product. The computer program product includes a non-transient computer-readable storage medium storing a computer program. When the computer program is read and executed by a computer, some or all steps of the foregoing method are implemented. The computer program product may be implemented by hardware, software, or a combination thereof. In some embodiments, the computer program product is embodied as a computer storage medium. In other embodiments, the computer program product is embodied as a software product, such as a software development kit (Software Development Kit, SDK), and the like.

Specially, it should be noted that the foregoing description of embodiments tends to emphasize differences among embodiments, and similarities may be referred to each other. The foregoing description of the embodiments of the device, the storage medium, the computer program, and the computer program product is similar to the foregoing description of the method embodiments and has similar beneficial effects as the method embodiments. For technical details not disclosed in the embodiments of the device, the storage medium, the computer program, and the computer program product of the present disclosure, reference may be made to the description of the method embodiments of the present disclosure.

It should be understood that references throughout the specification to “one embodiment” mean that a particular feature, structure, or characteristic related to the embodiment is included in at least one embodiment of the present disclosure. Therefore, occurrences of “in one embodiment” in various places throughout the specification do not necessarily refer to the same embodiment. Further, the particular features, structures, or characteristics may be combined in any suitable manner in one or more embodiments. It should be understood that, in various embodiments of the present disclosure, the magnitude of the serial numbers of the foregoing steps/processes does not imply an execution order. The execution order of the steps/processes should be determined by their functions and internal logic and should not impose any limitation on implementation processes of some embodiments of the present disclosure. The serial numbers of embodiments of the present disclosure are merely for description and do not represent superiority or inferiority of embodiments.

It should be noted that, in this specification, the terms “include,” “including,” or any other variations thereof are intended to cover a non-exclusive inclusion, such that a process, method, article, or apparatus that includes a series of elements not only includes those elements, but also includes other elements not expressly listed, or includes elements inherent to such process, method, article, or apparatus. Without further limitation, an element defined by the phrase “including a . . . ” does not preclude the presence of additional identical elements in the process, method, article, or apparatus that includes the element.

In some embodiments of the present disclosure, it should be understood that the disclosed apparatus and method may be implemented in other manners. The apparatus embodiments described above are merely illustrative. For example, division of units is merely a logical function division and may be different in actual implementation. For example, a plurality of units or components may be combined or integrated into another system, or some features may be omitted or not performed. In addition, coupling or direct coupling or communication connections among the components shown or discussed may be implemented through interfaces, and indirect coupling or communication connections between apparatuses or units may be electrical, mechanical, or in other forms.

Units described as separate components may or may not be physically separated. Components shown as units may or may not be physical units. The components may be located in one place or distributed on a plurality of network units. A part or all of the units may be selected according to actual requirements to implement the objectives of the solutions of the embodiments.

In addition, functional units in various embodiments of the present disclosure may be integrated into one processing unit, or each unit may exist as a separate unit, or two or more units may be integrated into one unit. The integrated units may be implemented in hardware or in a form combining hardware and software functional units.

Those of ordinary skill in the art should understand that all or some steps of the method embodiments described above may be implemented by hardware related to program instructions. The program may be stored in a computer-readable storage medium. When executed, the program executes steps including the steps of the foregoing method embodiments. The storage medium includes, for example, a mobile storage device, a read-only memory (Read Only Memory, ROM), a magnetic disk, an optical disk, or various media capable of storing program code.

Alternatively, if the integrated units of the present disclosure are implemented in the form of software functional modules and sold or used as an independent product, the integrated units may also be stored in a computer-readable storage medium. Based on such understanding, the technical solutions of the present disclosure, or a part contributing to related technologies, may be embodied in the form of a software product. The computer software product is stored in a storage medium and includes instructions that cause an electronic device (which may be a personal computer, a server, a network device, or the like) to perform all or some steps of the methods of some embodiments of the present disclosure. The storage medium includes, for example, a mobile storage device, a ROM, a magnetic disk, an optical disk, or various media capable of storing program code.

In some embodiments of the present disclosure, a target length corresponding to a target task is first determined. A first target model matching the target length is then selected from a plurality of first models. During inference using the first target model, because a length supported by the first target model is closest to the target length, padding applied to task input information corresponding to the target task is minimized. By adopting this approach, on one hand, execution efficiency of the first target model is improved, and waste of processor computing resources and bandwidth resources is reduced; and, on the other hand, model development workload is effectively reduced, and a model development cycle is shortened.

The foregoing describes only embodiments of the present disclosure, and the scope of protection of the present disclosure is not limited thereto. Any modifications or substitutions readily contemplated by those skilled in the art within the technical scope disclosed in the present disclosure should fall within the scope of protection of the present disclosure.

What is claimed is:

1. A method for task processing, comprising:
in response to a target task being triggered, determining a target length corresponding to the target task;
based on the target length, determining a first target model matching the target length from a plurality of first models, wherein each of the plurality of first models comprises a model library file and a configuration file, the configuration file being configured to define a supported task length of a respective first model, such that the plurality of first models support different task lengths; and
executing the target task using the first target model.

2. The method according to claim 1, further comprising:
obtaining a loading mode of a model, wherein the loading mode is determined based on resource information of a target space and information of the model, or is a selection of the loading mode received from a user; and
loading at least one model of the plurality of first models based on the loading mode of the model.

3. The method according to claim 2, wherein loading the at least one model of the plurality of first models based on the loading mode of the model comprises:
when the loading mode of the model is a first mode, obtaining a historical target length of a historical target task;
based on the historical target length, determining a second target model from the plurality of first models; and
loading the second target model into the target space.

4. The method according to claim 2, wherein loading the at least one model of the plurality of first models based on the loading mode of the model comprises:
when the loading mode of the model is a second mode, loading the plurality of first models into the target space, such that the first target model is determined from the plurality of first models loaded into the target space.

5. The method according to claim 4, further comprising:
when the loading mode of the model is the second mode, based on the resource information of the target space and a user's model usage behavior, determining a number of first models to be loaded and the first models to be loaded.

6. The method according to claim 3, wherein determining the first target model matching the target length from the plurality of first models based on the target length comprises:
when the second target model loaded into the target space is determined to match the target length, using the second target model loaded into the target space as the first target model to process the target task; and
when the second target model loaded into the target space is determined not to match the target length, determining the first target model matching the target length from the plurality of first models, loading the first target model into the target space, and removing the second target model loaded into the target space.

7. The method according to claim 1, wherein determining the target length corresponding to the target task comprises:
obtaining task input information corresponding to the target task;
when the task input information does not indicate an expected output length of the target task, determining the target length based on a first length; and
when the task input information indicates the expected output length, determining the target length based on the first length and the expected output length,
wherein the first length comprises a second length represented by the task input information, or comprises the second length and a third length represented by target information, the target information being associated with the task input information.

8. The method according to claim 1, further comprising:
when no new instruction is received within a predetermined time period after completion of the target task, removing the first target model or the plurality of first models from a target space.

9. An electronic device, comprising:
a memory configured to store a target application, wherein the target application is configured to receive user input triggering a target task; and
one or more processors configured to:
in response to the target task being triggered, determine a target length corresponding to the target task;
based on the target length, determine a first target model matching the target length from a plurality of first models, wherein each of the plurality of first models comprises a model library file and a configuration file, the configuration file being configured to define a supported task length of a respective first model, such that the plurality of first models support different task lengths; and
execute the target task using the first target model.

10. The electronic device according to claim 9, further comprising:
another memory, comprising a target space and configured to load the first target model, wherein the target task is executed using the first target model.

11. The electronic device according to claim 10, wherein the one or more processors are further configured to:
obtain a loading mode of a model, wherein the loading mode is determined based on resource information of the target space and information of the model, or is a selection of the loading mode received from a user; and
load at least one model of the plurality of first models based on the loading mode of the model.

12. The electronic device according to claim 11, wherein the one or more processors are further configured to:
when the loading mode of the model is a first mode, obtain a historical target length of a historical target task;
based on the historical target length, determine a second target model from the plurality of first models; and
load the second target model into the target space.

13. The electronic device according to claim 11, wherein the one or more processors are further configured to:
when the loading mode of the model is a second mode, load the plurality of first models into the target space, such that the first target model is determined from the plurality of first models loaded into the target space.

14. The electronic device according to claim 9, wherein the one or more processors are further configured to:
obtain task input information corresponding to the target task;
when the task input information does not indicate an expected output length of the target task, determine the target length based on a first length; and
when the task input information indicates the expected output length, determine the target length based on the first length and the expected output length,
wherein the first length comprises a second length represented by the task input information, or comprises the second length and a third length represented by target information associated with the task input information.

15. A non-transitory computer-readable storage medium storing a computer program that, when executed by at least one processor, causes the processor to perform operations comprising:
in response to a target task being triggered, determining a target length corresponding to the target task;
based on the target length, determining a first target model matching the target length from a plurality of first models, wherein each of the plurality of first models comprises a model library file and a configuration file, the configuration file being configured to define a supported task length of a respective first model, such that the plurality of first models support different task lengths; and
executing the target task using the first target model.

16. The non-transitory computer-readable storage medium according to claim 15, wherein the at least one processor is further configured to perform:
obtaining a loading mode of a model, wherein the loading mode is determined based on resource information of a target space and information of the model, or is a selection of the loading mode received from a user; and
loading at least one model of the plurality of first models based on the loading mode of the model.

17. The non-transitory computer-readable storage medium according to claim 16, wherein the at least one processor is further configured to perform:
when the loading mode of the model is a first mode, obtaining a historical target length of a historical target task;
determining a second target model from the plurality of first models based on the historical target length; and
loading the second target model into the target space.

18. The non-transitory computer-readable storage medium according to claim 16, wherein the at least one processor is further configured to perform:
when the loading mode of the model is a second mode, loading the plurality of first models into the target space, such that the first target model is determined from the plurality of first models loaded into the target space.

19. The non-transitory computer-readable storage medium according to claim 18, wherein the at least one processor is further configured to perform:
when the loading mode of the model is the second mode, based on the resource information of the target space and a user's model usage behavior, determining a number of first models to be loaded and the first models to be loaded.

20. The non-transitory computer-readable storage medium according to claim 15, wherein the at least one processor is further configured to perform:
when no new instruction is received within a predetermined time period after completion of the target task, removing the first target model or the plurality of first models from a target space.
